(19) United States
(12) Patent Application Publication
(10) Pub. No.: US 2006/0239806 A1
(43) Pub. Date: Oct. 26, 2006

(54) Mobile material placer and conveying system and method of placing and conveying material utilizing the same

(76) Inventor: James E. Yelton, Eugene, OR (US)

Correspondence Address: BELL, BOYD & LLOYD, LLC, PO BOX 1135, CHICAGO, IL, 60690-1135, US

(21) Appl. No.: 11/375,192

(22) Filed: Mar. 13, 2006

Related U.S. Application Data
(60) Provisional application No. 60/661,537, filed on Mar. 14, 2005.

(51) Int. Cl. B60P 1/00

(52) U.S. Cl. 414/502

(57) ABSTRACT

A mobile placer includes a material hopper, a primary conveyor configured to support the material hopper, a secondary conveyor having an in-feed end and a discharge end, wherein the in-feed end alignable with the primary conveyor, and a body coupled to an off-road frame configured to traverse rough terrain and that supports the primary and secondary conveyors. In another embodiment, a mobile placer includes an all-terrain frame having a first steering axle; and a second steering axle, wherein the second steering axle is independently steerable relative to the first steering axle. The mobile placer may further include a body pivotally coupled to the all-terrain frame, a material hopper coupled to the body and configured to receive and store material. Primary and secondary conveyors may be coupled to the body and configured to receive material stored by the material hopper and configured to receive material from the primary conveyor and discharge the material at a discharge end, respectively.

### PRIORITY CLAIM

This application is a non-provisional application of, and claims the priority benefit under 35 U.S.C. §119(e) to, U.S. Provisional Application No. 60/661,537 filed Mar. 14, 2005, titled “Mobile Conveying Apparatus and Method Thereof”, the entire contents of which are incorporated herein for all purposes.

### BACKGROUND

It is well known that many tasks such as: the construction of driveways, roadways, and asphalt surfaces; the back filling of retaining walls; and the distribution of aggregate, mulch, soil and the like, can be extremely labor intensive. For example, delivery of aggregate to a roadway construction site typically involves: (i) loading a dump truck at an aggregate storage facility, (ii) transporting the aggregate to the construction site, (iii) dumping the aggregate in a mound, (iv) manually filling a wheelbarrow, (v) wheeling the aggregate to a selected location, and (iv) dumping the wheelbarrow load at that location. Each of these steps involves a great deal of time and labor. Furthermore, at each of these steps material may be spilled, wasted or otherwise strewn about the construction site. This waste results in an unsightly and potentially environmentally hazardous construction site and can create a potential road hazard if gravel material is picked up by the tires of passing vehicles and thrown into the air. This unaccounted for and picked-up material can injure unprotected pedestrians or damage property such as the windshields of passing vehicles.

In order to address the inefficiencies inherent in these steps, a number of mobile placers have been designed. Unfortunately, these known mobile placers are often unwieldy and unable to maneuver across rough terrain to place material at the construction site. Thus, while known mobile placers may be more efficient than some types of manual labor, they cannot directly access the construction site. Rather, these mobile placers are restricted to the periphery of the construction site, for example, the level and more navigable areas, and utilize placer conveyors that extend beyond the length of the vehicle to propel the material to the desired location. However, this is not a complete solution because the mobile placer is still unable to access construction sites that offer rough terrain and thus may not be able to distribute material to all of the necessary locations.

Moreover, these known mobile placers are often unable to operate in a continuous manner and are required to be reloaded by another piece of equipment such as, for example, a back hoe or skid steer. This, in turn, requires and additional investment in equipment, additional maintenance and personnel costs and one more piece of equipment to account for and track. Thus, it would be desirable to provide a mobile placer that could operate in a continuous manner and address the shortcoming of these known systems.

It would be advantageous to provide a system, apparatus and/or method that addresses these limitations and simplifies the process of constructing and/or maintaining a roadway or distributing material around a construction site.

### BRIEF DESCRIPTION OF THE FIGURES

FIG. 1 is a side view of a mobile placer with a placing conveyor and an all-terrain drive mechanism.

FIG. 2 is a top view of a mobile placer with a placing conveyor and an all-terrain drive mechanism.

FIG. 3 is a partial top view of a mobile placer that includes four wheel steering and an all-terrain drive mechanism.

FIG. 4 is a partial top view of a mobile placer that includes four wheel steering and an all-terrain drive mechanism.

FIG. 5 is a rear view of a mobile placer that includes a leveling mechanism and an all-terrain drive mechanism, where the mobile placer is on flat ground.

FIG. 6 is a rear view of a mobile placer that includes a leveling mechanism and an all-terrain drive mechanism, where the mobile placer is on uneven ground.

FIG. 7 is a side view of a mobile placer with a feed conveyor.

FIG. 8 is a top view of a mobile placer with a feed conveyor.

FIG. 9 is a perspective view of a mobile placer with a feed conveyor, where the feed conveyor is in a transport position.

FIG. 10 is a side view of a mobile placer with a cab and mounted to a truck chassis.

FIG. 11 is a top view of a mobile placer with a cab and mounted to a truck chassis.

FIG. 12 is a front sectional view of a material hopper and primary conveyor mechanism, where the primary conveyor belt is chain driven.

FIG. 13 is an enlarged front sectional view of the material hopper and primary conveyor mechanism.

FIG. 14 is a front sectional view of a primary conveyor mechanism, where the primary conveyor belt is chain driven.

FIG. 15 is a top view of a chain driven conveyor belt for the primary conveyor mechanism.

FIG. 16 is a front sectional view of the chain driven conveyor belt shown in FIG. 15.

FIG. 17 is an enlarged front sectional view of a portion of the chain driven conveyor belt shown in FIG. 15.

### DETAILED DESCRIPTION

Generally, a mobile placer constructed according to the teachings of the present disclosure includes a body pivotally coupled to a frame, a material hopper attached to the body, a primary conveyor coupled to the body, wherein the primary conveyor is adapted to receive material from the material hopper, and a placer conveyer coupled to the body and adjustable relative to the body, wherein the placer conveyor is adapted to receive material from the primary conveyor.

In other embodiments, at least one leveling cylinder is pivotally coupled to the body and the frame and extends and retracts to pivot the body with respect to the frame.

In other embodiments, the mobile placer is cabless placer and includes a remote control for operating the mobile placer.

In another embodiment, the mobile placer includes a body provided on a frame, a feeder conveyor adjustably mounted to the frame and adjustable between a working position and a transport position. The mobile placer can further include a primary material hopper attached to the body and adapted to receive material from the feeder conveyor, a primary conveyor coupled to the body and adapted to receive material from the primary material hopper, and a placer conveyer coupled to the body and adjustable relative to the body to receive material from the primary conveyor.

In yet another embodiment, the mobile placer includes (a) a body provided on a frame, (b) a cab connected to the body, (c) a material hopper mounted to the body, (d) a cartridge type primary conveyor removably mounted to the body and adapted to receive material from the material hopper. The primary conveyor may include a flat conveyor belt that is at least eighteen inches wide and a placer conveyer coupled to the body and adjustable relative to the body, wherein the placer conveyor is adapted to receive material from the primary conveyor.

In yet another embodiment, the cartridge type primary conveyor includes a chain driven primary conveyor belt.

I. All-Terrain Mobile Placer

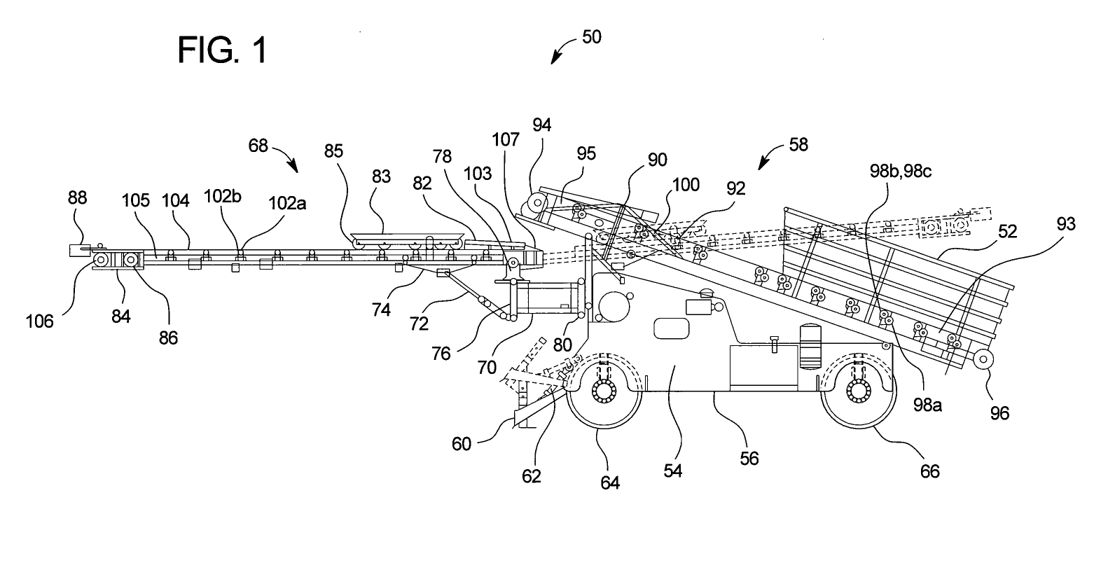

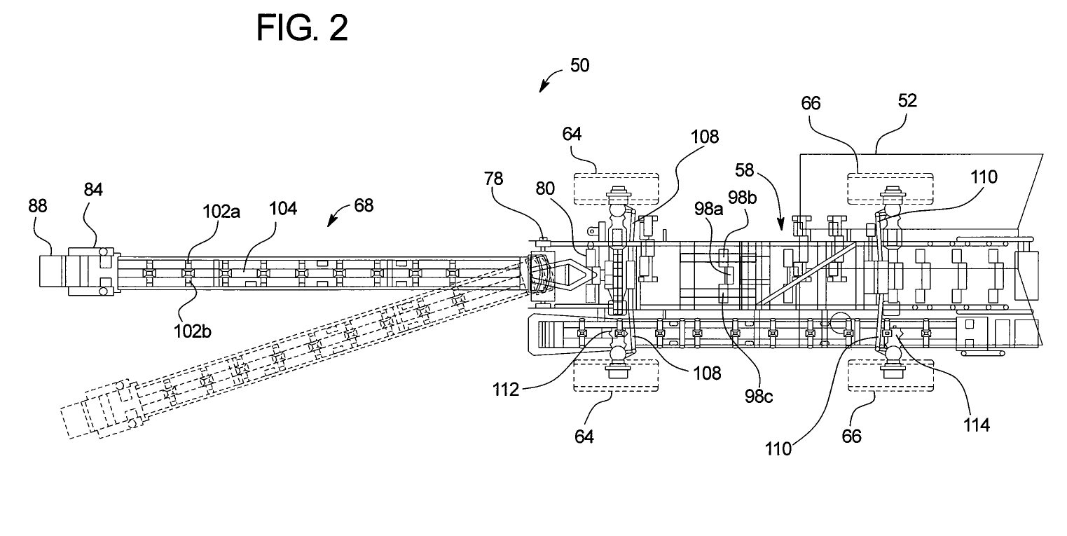

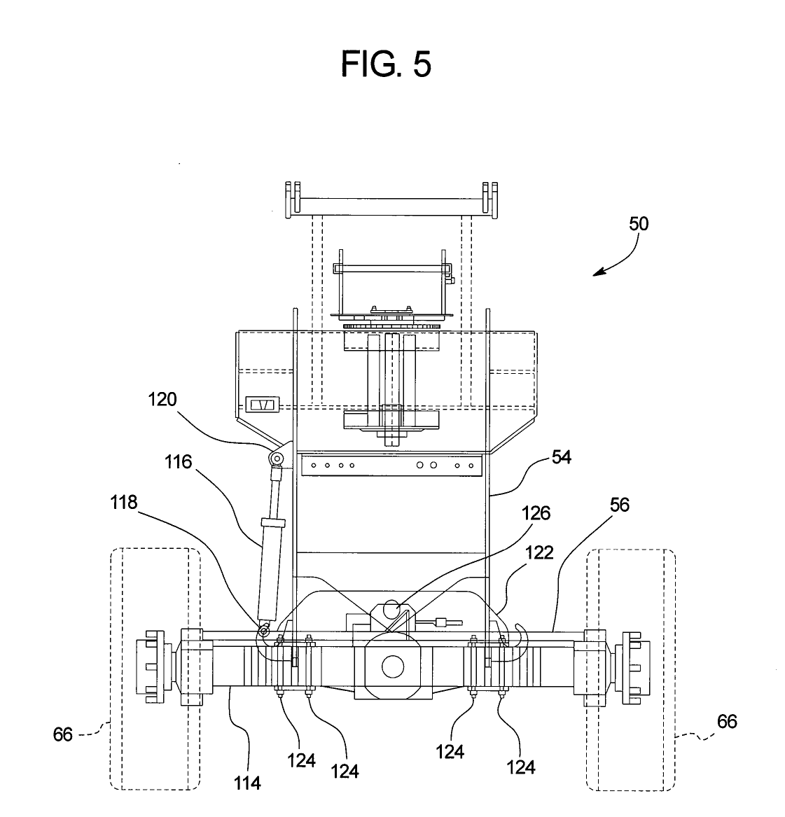

Turning to the figures, FIGS. 1 and 2 illustrate one example of a mobile placer 50 configured to travel and dispense material over rough terrain. The mobile placer 50 includes a body 54 coupled to and carried by a frame 56, a material hopper 52, a primary conveyor 58 and a placing conveyor 68. The mobile placer 50 includes an engine (not shown) and a drive train 118 (see FIG. 5). In one example, the engine may be a CATERPILLAR® model 3054C 86HP™ Tier 2 compliant engine. However, it should be appreciated that the engine may be any other suitable engine. The material hopper 52 is integrally mounted to the primary conveyor 58. The primary conveyor 58 is coupled to the body 54.

In operation, the material to be conveyed or dispensed is loaded into the material hopper 52 by, for example, a back how, skid steer or an excavator, and is gravity fed onto a first end of the primary conveyor 58. The material hopper 52 may be constructed of a high tensile steel such as ten gauge sheeting that rates for a load capacity of at least six cubic meters. It will be understood that the material hopper 52 could be constructed of any suitable material and may include a larger load capacity depending on the applications and requirements placed upon the equipment. The hopper 52 may further include one or more hopper extensions (not shown) that increase or extend the width of the hopper opening to facilitate loading.

The primary conveyor 58 includes a primary conveyor belt 92 that can, for example, be driven by a hydraulic drive mechanism (not shown). The primary conveyor belt 92 travels around a primary conveyor head roll 94 and a primary conveyor tail roll 96, and is supported by a number of troughing rollers 98a, 98b and 98c mounted below the upper surface of the primary conveyor belt 92. The troughing rollers 98a, 98b and 98c cooperate to contort the conveyor belt 92 into a trough-shape. In particular, the troughing roller 98a defines the substantially flat base of the trough, and the troughing rollers 98b and 98c define oblique angles relative to the troughing roller 98a such that the conveyor belt 92 is forced into a generally trough or v-shaped conveyor (not shown). The primary conveyor belt 92 may employ a twenty-four inch wide two-ply belt. In another embodiment, the primary conveyor belt 92 may include multiple cleats (not shown) extending from and permanently mounted to the primary conveyor belt 92. It will, however, be understood that a variety of suitable belts may be employed by the primary conveyor belt 92 depending upon the conveying and dispensing application.

In operation, the troughing rollers 98a, 98b and 98c facilitate the conveyance of material through an incline from an in-feed end 93 of the primary conveyor 58 to a discharge end 95 of the primary conveyor 58. Several sets of troughing rollers are arranged along the length of the primary conveyor 58 to help support the weight of the material. In one embodiment, additional sets of troughing rollers are installed adjacent to the in-feed end 93 of the primary conveyor 58 to support the greater mass of material contained in the material hopper 52. In another embodiment, the primary conveyor 58 can include one or more skirts (not shown) that partially constrain and control the material within the primary conveyor 58. Similarly, the primary conveyor 58 may include one or more primary conveyor skirt supports 100 that maintain the skirts in position.

After the material has been conveyed to the discharge end 95 of the primary conveyor 58, the material is provided to a placing conveyor 68. The placing conveyor 68 mounts to the body 54 of the mobile placer 50 via a swing arm assembly 70. The swing arm assembly 70 includes a swing arm hinge 76 mounted to defines a substantially vertical axis, a swing arm yoke 78 mounted to define a substantially horizontal axis, and a swing arm mounting bumper 80 coupled thereto. The placer conveyor 68 pivotally mounts to the swing arm yoke 78 at an in-feed end 103 of the placer conveyor 68. A conveyor lift cylinder 72 further supports a discharge end 105 of the placer conveyor 68. The placing conveyor lift cylinder 72 couples to the swing arm assembly 70 and mounts to the placer conveyor 68 via a placer conveyor upper cylinder mount 74.

The swing arm hinge 76 allows the placer conveyor 68 to rotate about the vertical axis defined by the centerline of the swing arm hinge 76. Thus, the placer conveyor 68 may rotate in a clockwise or counterclockwise direction, relative to the swing arm hinge 76, convey and dispense material in an arc around the mobile placer 50. Similarly, the placer conveyor lift cylinder 72 elevates or lowers the placer conveyor 68 relative to a pivot axis defined along the swing arm yoke 78. It will be understood that alternate arrangements of pivot points, hinges, or ball joints may be employed to allow the placer conveyor 68 to move in both lateral and vertical directions.

FIG. 1 illustrates one embodiment of the mobile placer 50 in which the in-feed end 103 of the placer conveyor 68 is located substantially below the discharge end 95 of the primary conveyor 58. In this configuration, material is conveyed along the primary conveyor belt 92 to the discharge edge 95 of the primary conveyor 58 and dropped from the primary conveyor belt 92 into a placer conveyor in-feed hopper 82 located at the in-feed end 103 of the placer conveyor 68.

A shield 83 mounts adjacent to the in-feed end 103 of the placer conveyor 68 and includes a shield conveyor belt (not shown) on the underside of the shield 83. The shield conveyor belt may be driven about a plurality of shield rollers 85 by a hydraulic drive (not shown). Typically, the shield conveyor belt drives at substantially the same velocity as the placer conveyor belt 104 such that the material is conveyed between a region defined by the lower surface of the shield conveyor belt and the upper surface of the placer conveyor belt 104. In an alternate embodiment, the shield 83 may be unpowered and able to freely travel around the shield rollers 85. The region defined between the shield conveyor belt and the placer conveyor belt 104, in this example, is a substantially parallel area spaced apart and arranged to partially compress, settle, and/or shape the conveyed material. The shield 83 may further be removably mounted to the placer conveyor 68 and adjustable with respect to the placer conveyor 68 to accommodate different types of material.

As illustrated in FIGS. 1 and 2, the placer conveyor 68 includes a plurality of sets of placer conveyor rollers 102a and 102b supporting the placer conveyor belt 104. A hydraulic drive mechanism in a motor assembly 86 can drive the placer conveyor belt 104. Alternatively, to prevent slippage of the placer conveyor 68, the hydraulic drive mechanism may include dual hydraulic drive motors with cogged belts (not shown). It will be understood that hydraulic drive mechanism may be selected from any suitable drive mechanism that allow the placer conveyor belt 104 to perform the desired tasks. The motor assembly is mounted in a placer conveyor head end frame 84. The placer conveyor belt 104 travels around a placer conveyor head roll 106 and a placer conveyor tail roll 107 and is supported by the troughing rollers 102a and 102b mounted below the upper surface of the placer conveyor belt 104. The troughing rollers 102a and 102b define axes oblique from the placer conveyor belt 104 such that the placer conveyor belt 104 forms a general trough-like or v-like shape. It should be appreciated that the troughing rollers 102a and/or 102b may be of any suitable type, any suitable number, and may be oriented horizontally such that the placer conveyor belt 104 forms a flat profile. Physically, the placer conveyor belt 104 may be a fourteen inch wide two-ply belt, and/or may include one or more cleats (not shown) extending from and permanently mounted to the placer conveyor belt 104.

In operation, the troughing rollers 102a and 102b guide and facilitate the movement of material from the in-feed end 103 of the placer conveyor 68 to the discharge end 105 of the placer conveyor 68. Several sets of troughing rollers 102a and 102b can be utilized along the length of the placer conveyor 68 to support and distribute the mass of the material being conveyed. As previously discussed, the placer conveyor 68 and the placer conveyor belt 104 are configured to deliver material when the placer conveyor 68 is in any inclined, horizontal, or declined orientation.

At the discharge end 105 of the placer conveyor 68 is an end frame 84 housing the place conveyor motor assembly 86. The motor assembly 86 drives the belt 104 around the placer conveyor head roller 106. In one embodiment, the placer conveyor 68 and the hydraulic drive and the motor assembly 86 may be operated at high speed to throw and project material away from the discharge end 105. The high speed motor assembly 86 may be configured to project or through material such as, for example, aggregate, across a job site to any desired location that may not be accessible to the mobile placer 50. For example in one application, material may be thrown between ten and a hundred feet to a desired location. A deflector 88 may be optionally attached to the end frame 84 to guide or direct the conveyed material in a specific direction. As shown in FIGS. 2 and 22, the deflector 88 is arranged to deflect material projected from the discharge end 105 of the placer conveyor 68 immediately into the ground. This type of deflection would be appropriate in, for example, a roadside application where it is not necessary to project the material over a long distance. In another example, the deflector 88 is adjusted so deflect the material upward to discharge the material into the air. This may be appropriate in an application with limited access where the placing conveyor 68 may not be able to pivot vertically. It should be appreciated that the deflector 88 may be adjustable, removable, permanently fixed, and may be of any suitable type.

II. Four Wheel Steering

FIG. 2 illustrates an embodiment of the mobile placer 50 that includes a four-wheel steering system to facilitate maneuvering in relatively confined areas. In this exemplary embodiment, the frame 56 includes a front axle 112 and a rear axle 114. The front and real axles 112, 114 may, for example, be twenty thousand pound crab steering axles or any other type suitable axle. Two front wheels 64 mount and attach to the front axle 112, and two rear wheels 66 mount and attach to the rear axle 114. The wheels may be 15″×19.5″ flotation tires. However, it should be appreciated that any suitable tires may be used that accommodate travel over relatively rough terrain. The front wheels 64 are connected to a tie rod (not shown) attached to a front axle steering linkage 108 and steered via a gear and linkage mechanisms coupled to a power steering mechanism that allows them to pivot through a limited angle in either direction. Similarly, the rear wheels 66 are connected to a tie rod (not shown) attached to a rear axle steering linkage 110 and may be pivoted through a limited angle as described above.

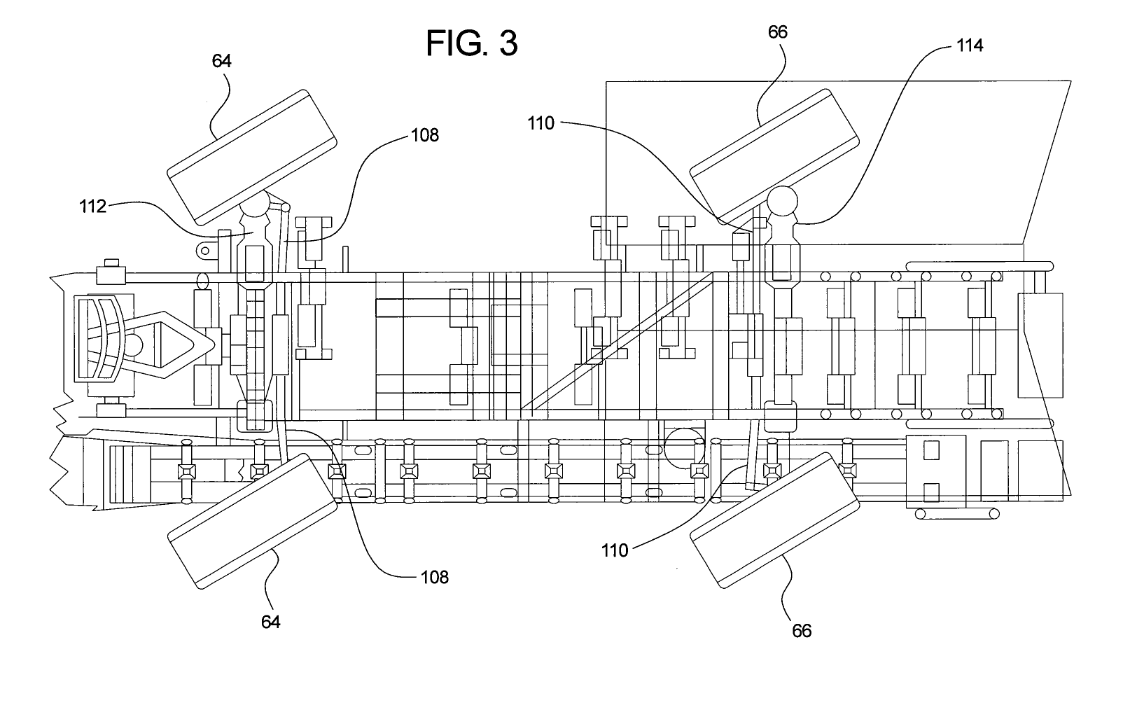

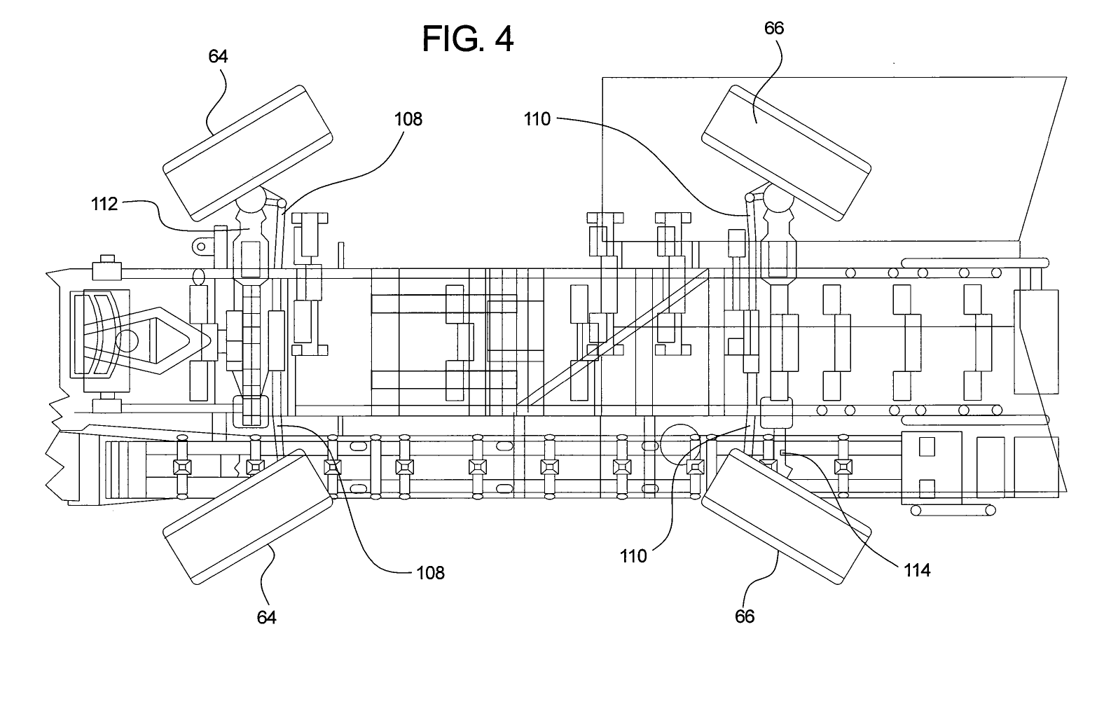

FIG. 3 illustrates the front and rear wheels 64, 66 arranged or pivoted in the same direction. FIG. 4 illustrates another arrangement in which the front and rear wheels 64, 66 are pivoted in opposite directions. As shown in FIG. 3, when the front and rear wheels 64 and 66 pivot in the same direction, the mobile placer 50 may move in a straight line with the body 54 of the mobile placer 50 aligned obliquely to the direction of travel. Alternatively, as shown in FIG. 4, when the front and rear wheels 64 and 66 pivot in opposite directions, the mobile placer 50 may turn in tight radius. In yet another alternate embodiment, the front wheels 64 may pivot independently of the rear wheels 66, or either the front 64 or rear 66 wheels may pivot while other wheels do not.

The mobile placer 50 can be operated by a remote control 300, such as a HECTRONIC™ radio remote control (see, FIG. 21). The remote control 300 may provide separate or tandem controls to pivot the front and rear wheels 64 and 66. Additionally, the remote control 300 system may include integrated traverse and placing control functions to control and align placer conveyor 68. In operation, the remote control 300 allows the operator to rotate and align the front wheels 64 in a first direction using one control, and rotate the rear wheels 66 in a second or even an opposite direction using another control. The flexible controls provided, at least, by the remote control 300 allow the mobile placer 50 to be maneuvered in virtually any direction required by the terrain. Accordingly, the mobile placer 50 is able to drive to locations and deposit materials inaccessible by existing placer systems. Moreover, the mobile placer 50, in combination with one or more of the: (i) flotation tires, (ii) flexible steering; (iv) off-road suspension, and (v) control system, allow for all-terrain capabilities and performance.

The mobile placer 50 also includes a blade 60 (see FIG. 1) that is pivotally coupled to a front end of the body 54. The blade 60 is pivotal about a hinge mounted to the front end of the body 54 and may function as both a stabilizer and a dozer blade capable of pushing or leveling material. A blade cylinder 62 couples with the blade 60 to pivot the blade 60 toward or away from the ground. The blade 60 may further include integrated stabilizers and an angle tilt mechanism (not shown).

III. Leveling and Stabilization

FIG. 5 illustrates an embodiment of the mobile placer 50 having all-terrain capabilities and optimized for travel over rough terrain. In operation, the mobile placer 50 may be required to travel over rough terrain to deliver a load, such that it could be necessary to dispense material while the mobile placer 50 is positioned on an inclined surface. To this a leveling cylinder 116 may be pivotally coupled to the frame 56 by a frame mounting bracket 118 and to the body 54 by a body mounting bracket 120. The leveling cylinder 116 is operable to retract or extend such that the body 54 of the mobile placer 50 can rotate about the pivot mount 126. Therefore, the body 54 is capable of being tilted relative to the frame 56.

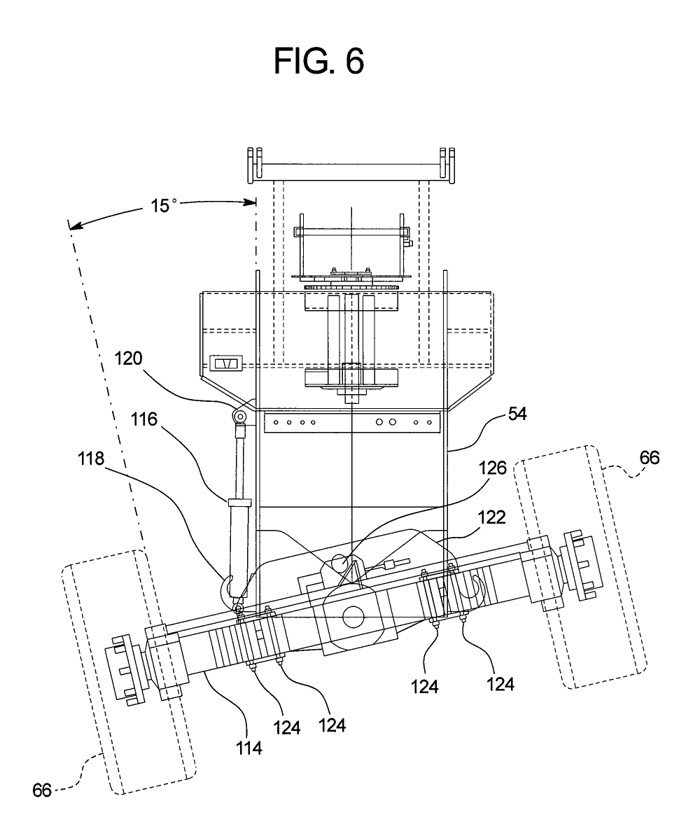

For example, the mobile placer 50 may need to travel through an uneven construction site or up a steep hill to reach the distribution site and be required to dispense material from a sloped surface. In this situation, the body 54, the primary conveyor 58 and the placer conveyor 68 would not be level. If the terrain is sufficiently uneven, the mobile placer 50 may not operate effectively. The leveling cylinder 116 may adjust the orientation of the primary conveyor 58, material hopper 52 and placer conveyor 68 relative to the body 54. FIG. 6 illustrates this condition where even though the frame 56, the axles 112, 114 and front and rear wheels 64, 66 are not level, the leveling cylinder 116 is capable of pivoting the hopper 52, etc. back to a standard operating, or level position.

As previously described, the HECTRONIC™ remote control may be utilized to remotely control the leveling cylinder 116. Alternatively, the mobile placer 50 may include a cab (not shown) and the leveling cylinder 116 may be controlled by an operator in the cab. The mobile placer 50 may further include a leveling sensor (not shown) configured to sense the orientation of the mobile placer 50 and cooperate with the leveling cylinder 116 to automatically or semi-automatically adjustment inclination or orientation of the hopper 52, etc. In one example of this embodiment, the automatic adjustment is performed according to a predetermined set of rules stored on a memory device and executed by a processor. In another example, the leveling cylinder 116 may continuously adjust as the mobile placer 50 travels over uneven terrain. Therefore, the primary conveyor 58 and material hopper 52 would continuously be adjusted toward a normal operating position. In another embodiment, the leveling cylinder 116 may operate in a semiautomatic mode.

In another embodiment the operator may selectively execute a leveling command after the mobile placer 50 reaches a destination and has stopped moving. Once the leveling command is executed, the leveling cylinder 116 extends or retracts until the leveling sensor determines that the body 54 is in a level position. The leveling cylinder 116 may further be activated by the operator or automatically activated only after the mobile placer 50 has remained stationary for a predetermined period of time.

IV. Mobile Placer with Adjustable Feeder Conveyor

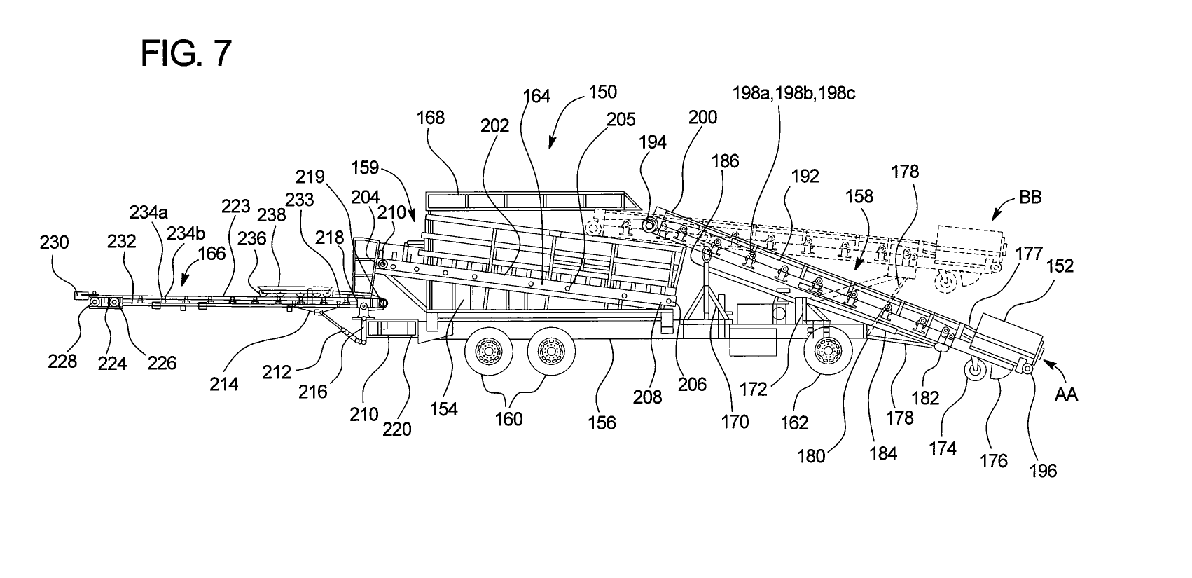

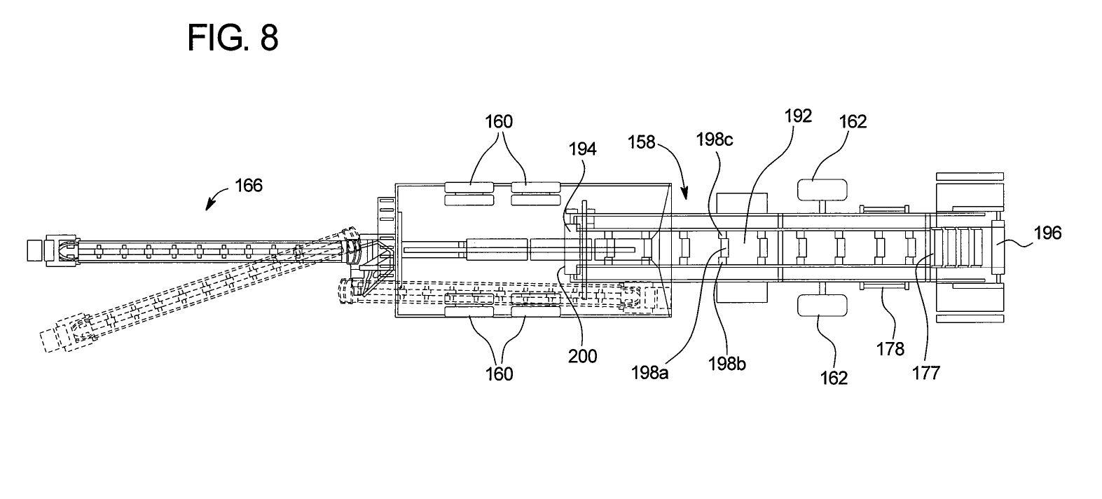

FIGS. 7 and 8 illustrate another embodiment of a mobile placer 150 is configured to operate and dispense materials in a continuous fashion. The mobile placer 150 includes a feeder conveyor 158, a primary conveyor 159 and a placer conveyor 166. The mobile placer 150 further includes a main body 154 coupled to a frame 156, and an engine and a drive train. The engine may be a CATEPILLAR® 3056E 176HP™ ATTAC Tier 2 compliant diesel engine or any other suitable engine type. A material hopper 168 may be integrally mounted to the body 154 and a primary conveyor 159 may be mounted to the body 154.

The feeder conveyor 158 in this exemplary embodiment adjustably mounts to the frame 156 of the mobile placer 150. As shown in FIG. 7, the feeder conveyor is operable in both a working position AA and a transport position BB. In the working position AA, a hoist frame 170, a secondary support frame 172, a feeder conveyor wheel 174, and a steel stop 176 supports the feeder conveyor 158. The feeder conveyor wheel 174 adjustably or spring mounts to an in-feed end 178 of the feeder conveyor 158. As the feeder conveyor is moved from the transport position BB to the working position AA, the feeder conveyor wheel 174 makes contact with the ground and continues to roll in a direction away from the frame. When the feeder material hopper 152 is empty, the hoist frame 170 and the secondary support frame 172 supports the full weight of the feeder conveyor 158 such that the feeder conveyor wheel 174 is free to rotate and the steel stop 176 does not make contact with the ground. When the feeder material hopper 152 is loaded with material from, for example, a dump truck or excavator, the added weight of the material compresses the spring loaded feeder conveyor wheel 174 and the steel stop 176 make contact with the ground. The steel stop 176 is capable of supporting the hopper 152 during the loading process and further protects the feeder conveyor wheel 174 from damage. The steel stop 176 also functions to provide friction between the feeder conveyor 158 and the ground to help prevent the feeder conveyor 158 from moving during the load operation. When the loading operation is complete and the feeder material hopper 152 is empty, the biasing force of spring in the feeder conveyor wheel 174 functions to lift the feeder conveyor 158 a small amount such that the steel stop 176 no longer makes contact with the ground and the feeder conveyor wheel 174 is again free to roll.

In one exemplary embodiment, the mobile placer 150 may be configured to move during the feed operation. For example, the biasing force of the spring in the feeder conveyor wheel 174 is sufficient to keep the steel stop 176 out of contact with the ground even when the feeder material hopper 152 is full. Therefore, the mobile placer 150 can move in tandem with, for example, a dump truck, while the dump truck empties a load of material into the feeder material hopper 152. Therefore, the mobile placer 150 does not have to temporarily stop to refill the primary hopper 168 and may operate in a continuous manner. The steel stop 176 may protect the wheel 174 from damage when an excess force is applied to the feeder material hopper 152. The feeder conveyor 158, in turn, may include a sensor to indicate if the steel stop 176 has made contact with the ground and either stop the mobile placer 150 or signal the operator.

In the transport position BB, a hoist frame 170 and a feeder conveyor support rod 178 supports the feeder conveyor 158. The support rod 178 is pivotally connected to the rear end of the frame 156 by a first support rod hinge 180 and is pivotally connected to the feeder conveyor 158 by a second support rod hinge 182. In the working position AA, the support rod 178 is oriented in a substantially horizontal position and is pivoted upwardly about the first support rod hinge 180 as the mobile placer 150 moves into the transport position BB. The mobile placer 150 is moved into the transport position BB by a transport cylinder 184 and a hoist frame cylinder 186. The transport cylinder 184 may be pivotally connected to the secondary support frame 172 and the second support hinge 182, or may connect to a different hinge mounted on the feeder conveyor 158. Similarly, the hoist frame cylinder 186 mounts to the hoist frame 170 and is slidably connects to the feeder conveyor 158 in any suitable manner. In operation, the transport cylinder 184 retracts while the hoist frame cylinder 186 extends to move the feeder conveyor 158 from the working position AA to the transport position BB. The mobile placer 150 may also include a series of straps or tie-downs (not shown) to further secure the feeder conveyor 158 in the transport position BB.

With the feeder conveyor 158 in the working position AA, the material to be dispensed is loaded into the feeder hopper 152 by, for example, a dump truck or an excavator and is gravity fed onto a first end 177 of the feeder conveyor 158. The feeder hopper 152 may be, for example, a butterfly hopper composed of a high tensile steel with ten gauge sheeting having a load capacity sufficient to accept the material from the dump truck. It will be understood that the material selection for the feeder hopper 152, or any other element or component described herein may be altered or selected to satisfy the performance requirements of the mobile placer 150. The hopper 152 may further include one or more hopper extensions (not shown) to increase the overall width of the hopper opening and accommodate wide loading by, for example, a front end loader.

The feeder conveyor 158 may include a feeder conveyor belt 192 that is driven by, for example, a hydraulic drive mechanism (not shown). The feeder conveyor belt 192 travels around a feeder conveyor head roll 194 and a feeder conveyor tail roll 196 and is supported by several feeder troughing rollers 198a, 198b and 198c mounted below the upper surface of the feeder conveyor belt 192. The feeder troughing roller 198a can defines the base of the trough, while feeder troughing rollers 198b and 198c define or contort the sides or edges of the feeder conveyor belt 192 to create a general trough-like shape conveyor wherein the sides define an oblique angle relative to the base. The feeder conveyor 158 may further include additional feeder troughing rollers 198a, 198b and 198c near the in-feed end 177 of the feeder conveyor 158 (see FIG. 8) that support the greater mass of material contained in the material hopper 152. Alternatively, the rollers 198a, 198b, and 198c near the in-feed end 177 of the feeder conveyor 58 may be one flat roller, such that the feeder conveyor belt 192 has a flat shape at the loading area. It should be appreciated that more than one feeder conveyor belt 192 may be used for the feeder conveyor 158. The feeder conveyor belt 192 may be an eighteen inch wide two-ply troughing belt or may have include one or more cleats, have a different width, or be composed of a different material. Thus, it will be understood that any task-suitable conveyor belt may be mounted and used as the feeder conveyor belt 192.

As will be understood from FIG. 7, the feeder troughing rollers 198a, 198b and 198c facilitate the conveyance of material through an incline from an in-feed end 177 of the feeder conveyor 158 to a discharge end 200 of the feeder conveyor 158. Several sets of feeder troughing rollers 198a, 198b and 198c are arranged along the length of the feeder conveyor 158 to help support the weight of the material. In one embodiment, the feeder conveyor 158 includes one or more skirts and skirt supports as discussed above.

After the material has been conveyed to the discharge end 200 of the feeder conveyor 158, the material is discharged into a primary hopper 168. In one embodiment, the primary hopper 168 has a twenty cubic yard capacity and is composed of high tensile steel with ten gauge sheeting. However, as previously discussed, the material may be altered or selected, for example, to satisfy and task-specific or manufacturing concern. The primary hopper 168 may include a vibratory agitator with a timer to facilitate the transport of material from the hopper 168 down to the primary conveyor 159. In other exemplary embodiments, the primary hopper 168 may be spring mounted to the frame 156, and/or may include exterior mounted skirt adjustments (not shown).

The primary conveyor 159 includes a primary conveyor belt 202 that is driven by, for example, a hydraulic drive mechanism (not shown). The primary conveyor 159 may further include hydraulic folding wings (not shown) to facilitate the loading and storage of material. The primary conveyor belt 202 travels around a primary conveyor head roll 204 and a primary conveyor tail roll 206 and is supported by several sets of primary troughing rollers 205, similar with respect to the feeder troughing rollers 198a, 198b and 198c discussed above. In one example, the primary conveyor belt 202 may be a thirty-six inch wide 330 two-ply troughing belt. As previously described, the primary conveyor belt 202 may include one or more cleats (not shown) extending from and permanently mounted to the belt 202 or may be any other suitable type of placing conveyor belt 202.

As further illustrated in FIG. 7, the primary troughing rollers 205 facilitate the conveyance of material through an incline from an in-feed end 208 of the primary conveyor 159 to a discharge end 210 of the primary conveyor 159. In the illustrates exemplary embodiment, several sets of troughing rollers 205 are arranged along the length of the primary conveyor 159 to help support the weight of the material, additional sets of troughing rollers 205 may be positioned adjacent to the in-feed end 208 of the primary conveyor 159 to help support the greater mass of material contained in the primary hopper 168 as discussed above. In one embodiment, the primary conveyor 168 includes one or more skirts and one or more primary conveyor skirt supports as discussed above.

The primary conveyor 159 may be a positive start cartridge type conveyor with a non-troughing conveyor belt that defines a track that is at least twenty inches wide that may or may not be cleated. The cartridge type primary conveyor may be manufactured as a stand-alone unit and may mate or slide into the body 154 of the mobile placer 150. The cartridge type primary conveyor may be removed or slid out of the body 154 at any time for repair or replacement.

After the material has been conveyed to the discharge end 210 of the primary conveyor 159, the material is provided to the placer conveyor 166. Generally, the placer conveyor 166 may function in essentially the same manner, and includes similar components as the placer conveyor 166 discussed above with reference to FIG. 1. The placer conveyor 166 attaches to the body 154 of the mobile placer through a swing arm assembly 210. The swing arm assembly 210 includes a swing arm hinge 216 that defines a substantially vertical axis, a swing arm yoke 218 that defines a substantially horizontal axis, and a swing arm mounting bumper 220. The placer conveyor 166 is pivotally mounted to the swing arm yoke 218 at the in-feed end 233 of the placer conveyor 166.

The placer conveyor 166 is further supported by a placer conveyor lift cylinder 212 at another location closer to the discharge end 232 of the placer conveyor 166. One end of the placer conveyor lift cylinder 212 is pivotally coupled to the swing arm assembly 210 and the other end is pivotally mounted to the placer conveyor by a placer conveyor upper cylinder mount 214. The swing arm hinge 216 enables the placer conveyor 166 to rotate about the vertical axis defined the swing arm hinge 216. Therefore, the placer conveyor 166 is able to rotate in a clockwise or counterclockwise direction to place the material as discussed above with regard to FIG. 1. The placer conveyor lift cylinder 212 moves the placer conveyor 166 up and down while pivoting around the horizontal axis defined by the swing arm yoke 218. It should be appreciated that any suitable combination of pivot points, hinges, or ball joints could be used in order to allow the placer conveyor 166 to move in both lateral and vertical directions.

In one embodiment, the in-feed end 233 of the placer conveyor 166 is located substantially below the discharge end 210 of the primary conveyor 159. Therefore, as the material is conveyed over the discharge edge of the primary conveyor 210, the material drops from the primary conveyor belt 159 onto the placer conveyor 166.

In another embodiment, the placer conveyor includes a shield 238 mounted near the in-feed end 233 of the placer conveyor 166. In one embodiment, the shield 238 includes a shield conveyor belt (not shown) on the underside of the shield. The shield conveyor belt may include a hydraulic drive (not shown) that drives the shield conveyor belt about a plurality of shield rollers 236. The shield and associated components function as discussed above in reference to FIG. 1.

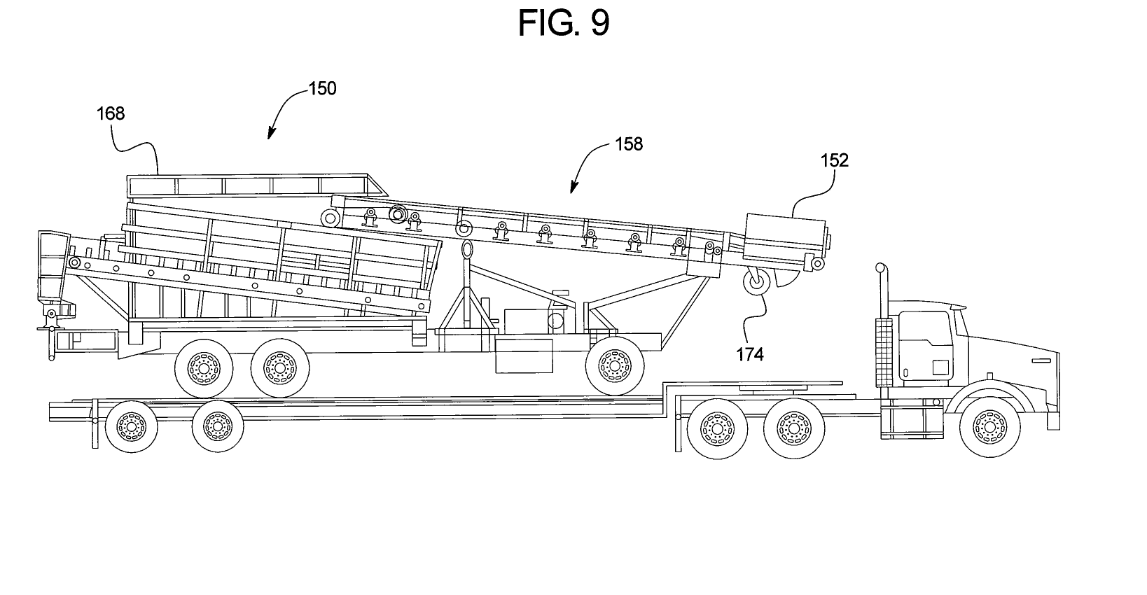

FIGS. 8 and 9 illustrate that the placer conveyor includes a plurality of sets of placer conveyor troughing rollers 234a and 234b supporting the placer conveyor belt 223. The placer conveyor belt 223 is driven by, for example, a hydraulic drive mechanism in a motor assembly 226. The motor assembly 226 may be a high speed motor assembly configured to project or through material such as, for example, aggregate, across a job site to any desired location that may not be accessible to the mobile placer 150. For example in one application, material may be thrown between ten and a hundred feet to a desired location. Alternatively, the placing conveyor 166 may includes dual hydraulic drive motors with cogged belts (not shown). The motor assembly is mounted in a placer conveyor head end frame 224. The placer conveyor belt 223 travels around a placer conveyor head roll 228 and a placer conveyor tail roll 219 and is supported by the troughing rollers 234a and 234b mounted below the upper surface of the placer conveyor belt 223. In one embodiment, the troughing rollers 234a and 234b define axes oblique from the placer conveyor belt 223 such that the belt 223 forms a general trough-like or v-like shape. It should be appreciated that the rollers 234a and 234b may be of any suitable type, any suitable number, and may oriented horizontally such that the placer conveyor belt 223 forms a flat profile. In one example, the placer conveyor belt 223 may be fourteen inch wide two-ply belt. Alternatively, the placer conveyor belt 223 may be a flat belt, may include one or more of cleats (not shown) extending from and permanently mounted to the belt 223.

As illustrated in FIGS. 7 and 8, the troughing rollers 234a and 234b facilitate the conveyance of material from the in-feed end 233 of the placer conveyor 166 to the discharge end 232 of the placer conveyor 166. Several sets of troughing rollers 234a and 234b are arranged along the length of the placer conveyor 166 to help support the mass of the material. The placer conveyor belt 223 is configured to allow material to be conveyed when the placer conveyor 166 is in an inclined, horizontal, or declined position.

At the discharge end 232 of the placer conveyor 166 is an end frame 224 housing the placer conveyor motor assembly 226. The motor assembly drives the belt 223 around the placer conveyor head roller 228 and the placer conveyor tail roller 219. Attached to either the placer conveyor 166 or the end frame 224 is a deflector 230 for directing the conveyed material in a specific direction. The deflector 230, as shown in FIG. 22, functions as described above with respect to FIGS. 1 and 2.

In one embodiment the mobile placer 150 does not include a cab and is operated by a remote control 300, such as a Hetronic™ radio remote control. The remote control 300 can be configured with separate controls for operating the feeder conveyor 158, the primary conveyor 159 and the placer conveyor 166. The remote control 300 would also include a control to enable the entire mobile placer 150 to move forward and reverse and to be steered in different directions.

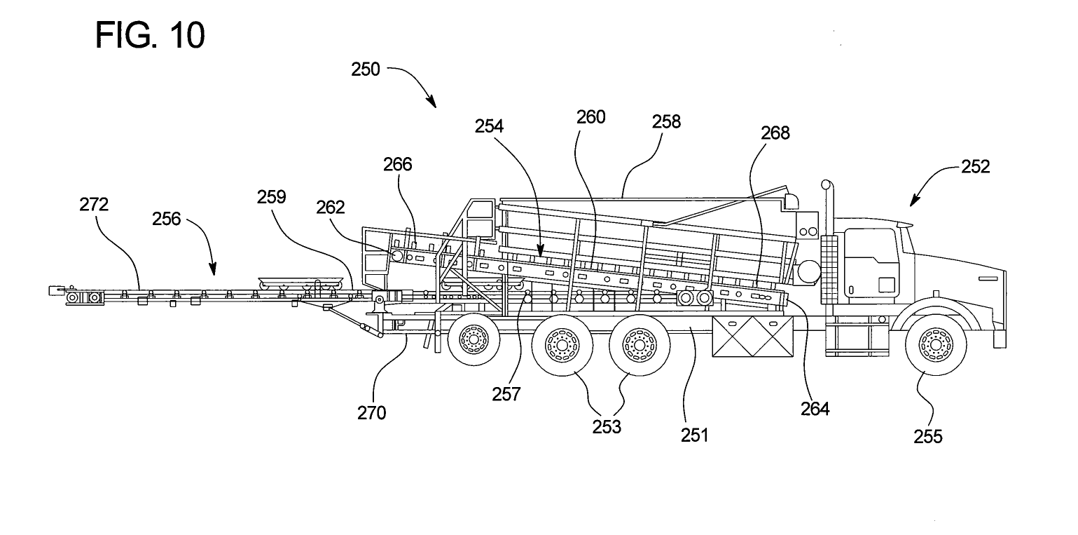

FIG. 10 illustrates the mobile placer 150 in the transport position BB. As shown, the placer conveyor 166 is rotable about an approximately one-hundred eighty degrees arc such that the placer conveyor 166 is positioned adjacent to the primary hopper 168. In this manner, the mobile placer 150 is converted into a relatively compact unit that can fit onto a tractor-trailer for transportation to a worksite.

V. Truck Placer with Wide Chain Driven Belt

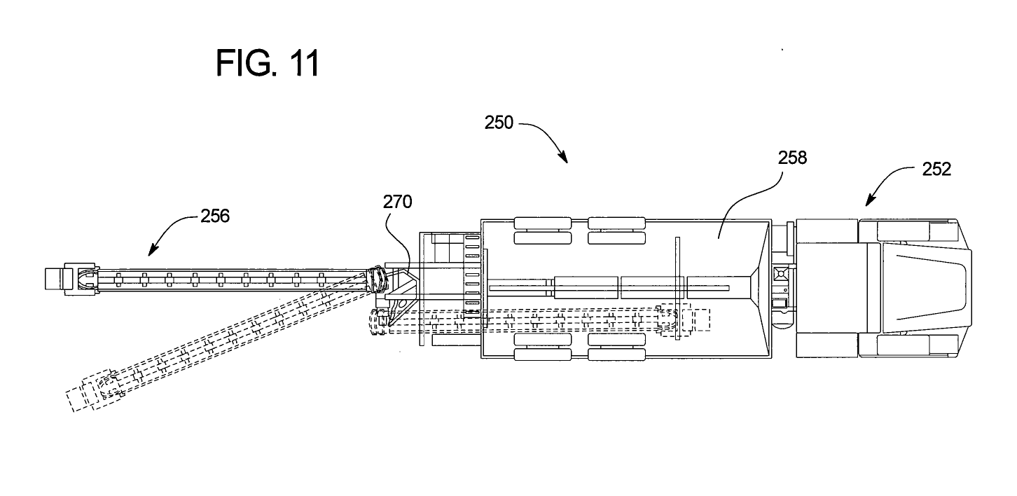

FIGS. 10 and 11 illustrate a mobile placer 250 is configured to operate on a truck chassis such as, for example, a KENWORTH® T-800 premium truck chassis. It should be appreciated that any suitable chassis may be used. In this exemplary embodiment, the mobile placer 250 is mounted to a truck frame 251, which includes, for example, a SPICER® EFA twenty-thousand pound (lb) front axel and a SPICER® DSH forty-thousand pound (lb) rear axel. However, any suitable frame and axel may be used. Mounted to the rear axel is at least one set of rear tires, 253 and mounted to the front axel is one set of front tires 255. The mobile placer 250 also includes a material hopper 258, a primary conveyor 254 and a placer conveyor 256. The mobile placer 250 also includes a truck cab 252 and an engine. In one example, the engine may be a CATERPILLAR® C-13 engine with four hundred-thirty horsepower (hp) and sixteen-hundred and fifty lb-ft of torque. However, it should be appreciated that the engine may be any other suitable type. The material hopper 258 is integrally mounted to the frame 251 of the mobile placer 250.

The material to be dispensed is loaded into the material hopper 258 by, for example, a front-end loader or an excavator and is gravity fed onto a first end 268 of the primary conveyor 254. The hopper 258 may be composed of a high tensile steel with 10 gauge sheeting having a load capacity of at least sixteen cubic yards, or any suitable material and may include a larger or smaller load capacity. Also, the hopper 258 may optionally include one or more hopper extensions as discussed above.

In one embodiment, the primary conveyor 154 includes a primary conveyor belt 260 that travels around a primary conveyor head roll 262 and a primary conveyor tail roll 264. The primary conveyor belt 260 is further supported by several sets of troughing rollers as discussed above. In one example, the primary conveyor belt 260 may be an eighteen inch wide two-ply troughing belt. In one embodiment, the primary conveyor belt 260 may have any number of cleats as discussed above. It should be appreciated that any suitable type of primary conveyor belt 260 may be used.

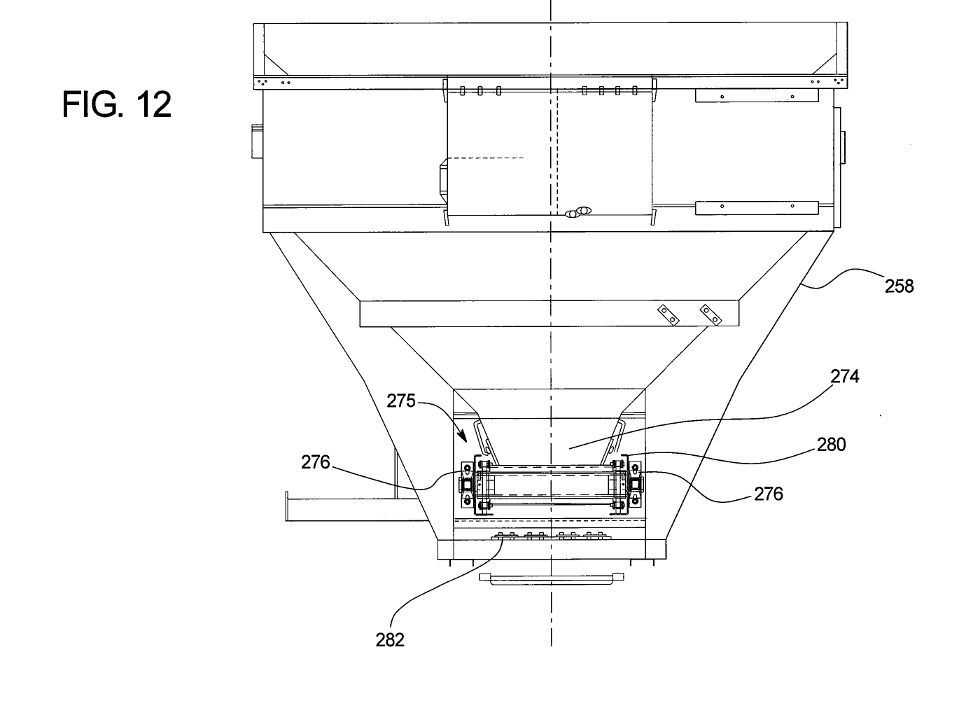

FIG. 12 illustrates another embodiment in which the primary conveyor 275 is a positive start cartridge type with a non-troughing conveyor belt. The track of the primary conveyor 275 is at least twenty inches wide to accommodate a larger variety of materials through the bottom opening 274 in the material hopper 258. However, it should be appreciated that the primary conveyor belt 260 may be of any suitable width. The cartridge type primary conveyor 275 may be manufactured as a self-contained unit and may slide into the body 257 of the mobile placer 250. The cartridge type primary conveyor 275 may be slid out of the body 257 at any time for repair or replacement. In another embodiment, the cartridge type primary conveyor 275 may also be cleated as discussed above.

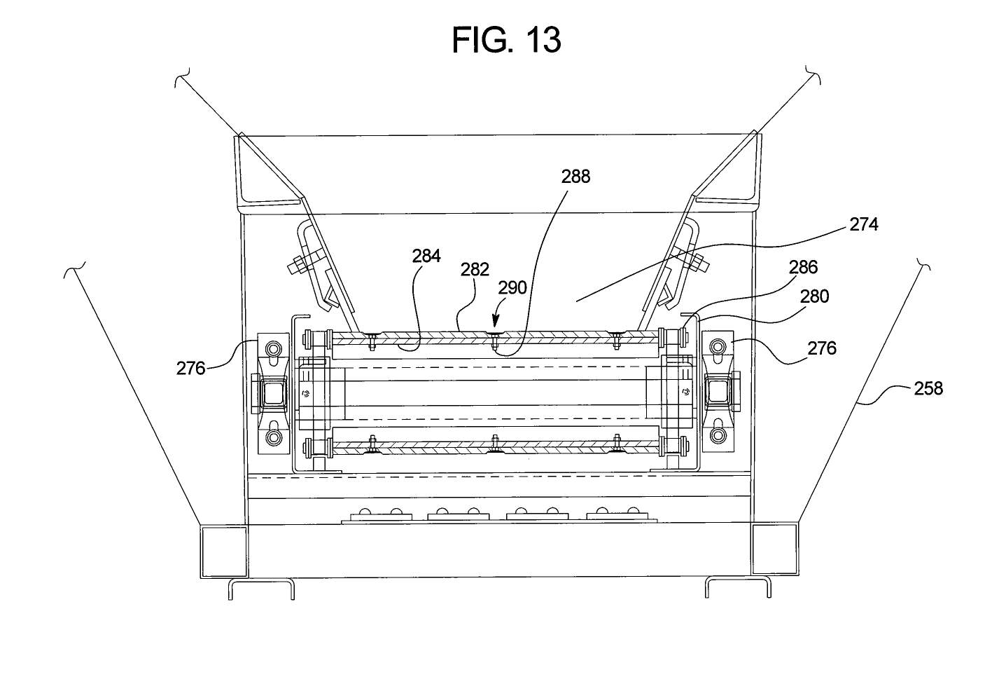

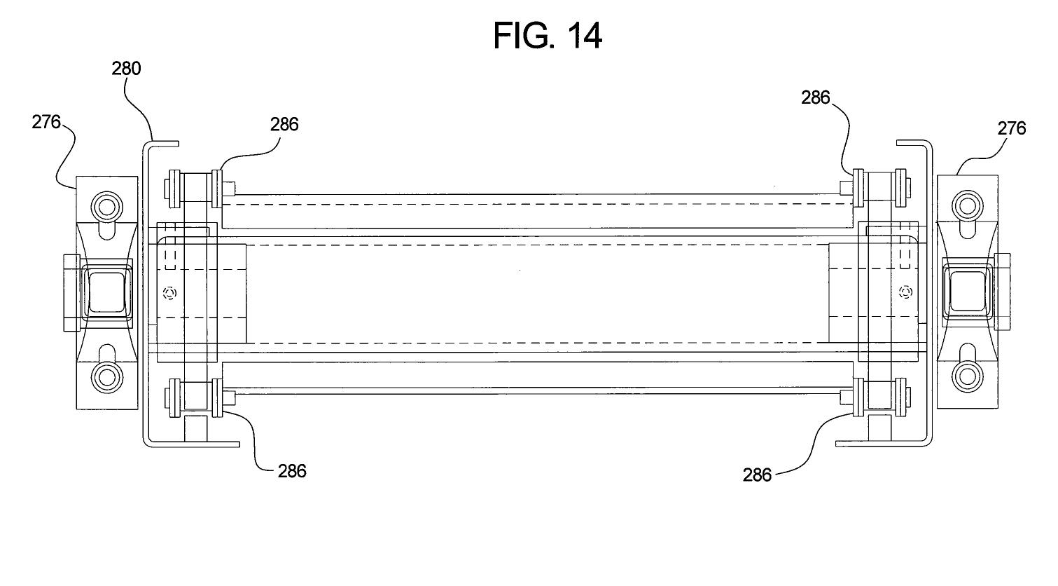

FIGS. 13 and 14 illustrate another embodiment in which the primary conveyor 275 is chain driven and includes a plurality of chain links 286 mounted around a gear (not shown) and connected to form a continuous chain. In one embodiment, the primary conveyor 275 includes a conveyor mount 280, a drive assembly 276 and a primary conveyor belt 282. In one example, the conveyor mount 280 is mounted to the frame 251 of the mobile placer 250. The drive assembly 276 is mounted to the conveyor mount 280. In one embodiment, the drive assembly includes a set of gears (not shown) having teeth that engage the chains links 286 and drive the chains in a particular direction.

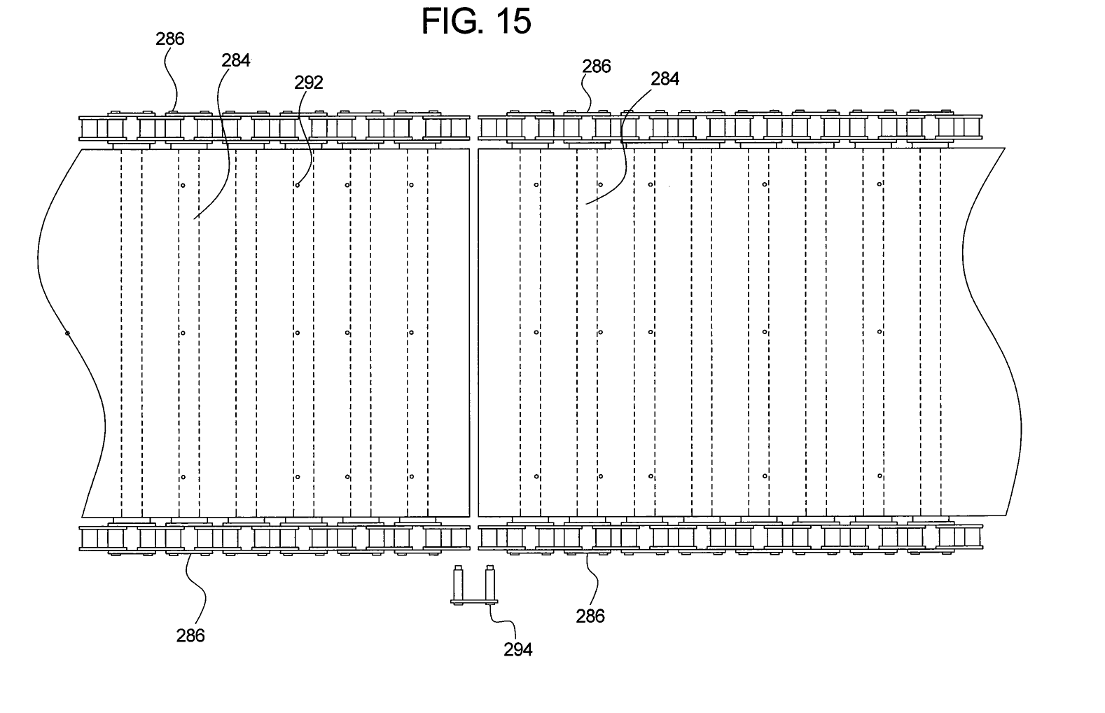

FIG. 15 illustrates the chain driven conveyor belt 282 may also include several stiffeners 284 between and fixed to each set of chain links 286. Each stiffener 284 includes several holes 292 spaced apart a certain distance.

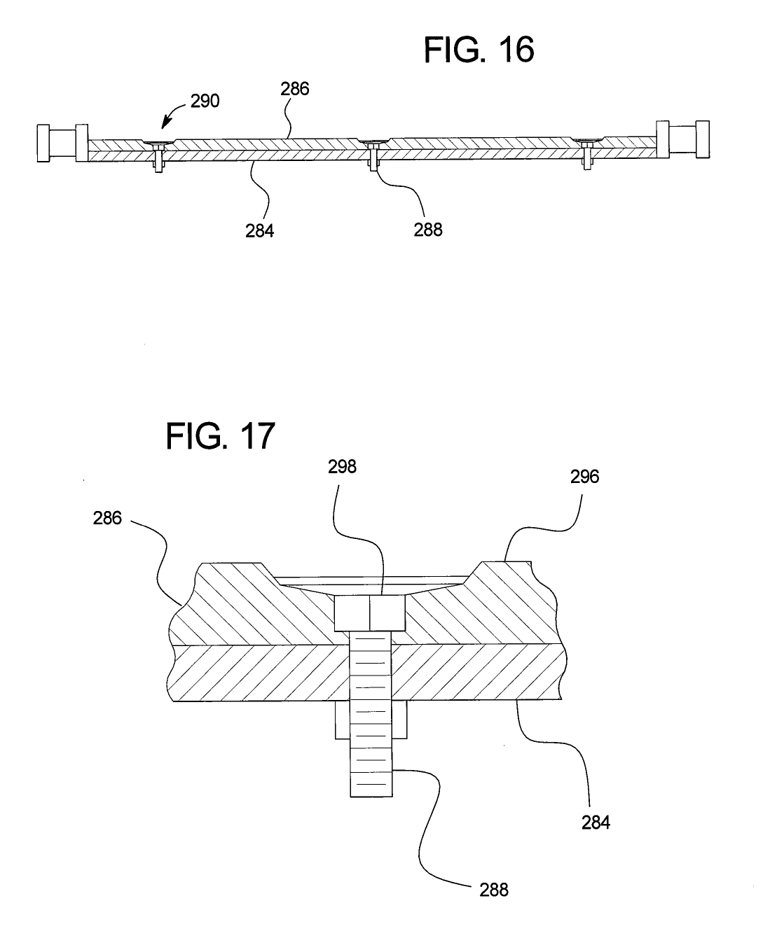

FIGS. 16 and 17 illustrates a flexible conveyor belt 286 mounted to the stiffeners 284 by bolts 288 at each of the holes 292. At each position where the conveyor belt is mounted to the stiffeners 284, the conveyor belt has a recessed surface 298 such that the bolt 288 mounts within the recess 298. Therefore, the top surface of the bolt 288 is lower than the top surface 296 of the flexible conveyor belt such that the bolt 288 does not interfere with the conveyance of material.

Referring back to FIG. 10, the troughing rollers and the primary conveyor belt 260 or the chain driven conveyor belt 275 facilitate the conveyance of material through an incline from an in-feed end 268 of the primary conveyor 260 to a discharge end 266 of the primary conveyor 254. If, for example, troughing rollers are to be utilized in an application, several sets of troughing rollers may be arranged along the length of the primary conveyor 260 to help support the weight of the material being conveyed. Moreover, additional sets of troughing rollers may be positioned near the in-feed end 268 of the primary conveyor 254. In this embodiment, the greater number of troughing rollers at the in-feed end 268 of the primary conveyor 254 help support the greater mass of material contained in the material hopper 258. In one embodiment, the primary conveyor 254 includes one or more skirts and one or more primary conveyor skirt supports as described above.

After the material has been conveyed to the discharge end 266 of the primary conveyor 254, the material is provided onto the placing conveyor 256. The placing conveyor 256 is attached to the body 257 of the mobile placer 250 through a swing arm assembly 270 as described above.

In one embodiment, the placer conveyor 256 may be coupled to a high speed motor assembly (not shown in FIG. 10, see FIG. 1 for an example) configured to project or through material such as, for example, aggregate, across a job site to any desired location that may not be accessible to the mobile placer 250. For example in one application, material may be thrown between ten and a hundred feet to a desired location.

In one embodiment, the in-feed end 259 of the placer conveyor 256 is located substantially below the discharge end 266 of the primary conveyor 254. Therefore, as the material is conveyed over the discharge edge 266 of the primary conveyor 256, the material drops from the primary conveyor belt 260 onto the placer conveyor 256. In one embodiment, the placer conveyor 256 operates substantially as described above.

In one embodiment, the mobile placer 250 additionally includes a remote control 300, such as a HECTRONIC™ radio remote control, that allows the operator to either manually drive the truck into position or get out of the truck cab 252 and control the mobile placer with the remote control 300. The remote control 300 may be provided with separate controls for operating the mobile placer 250 as described above.

In one embodiment, the placer conveyor 256 is operable to be rotated approximately one-hundred eighty degrees such that the placer conveyor 256 is positioned adjacent to the primary hopper 258. In this example, the mobile placer 250 is converted into a relatively compact unit that can be driven along a roadway.

It should be understood that various changes and modifications to the presently preferred embodiments described herein will be apparent to those skilled in the art. Such changes and modifications can be made without departing from the spirit and scope of the present invention and without diminishing its intended advantages. It is therefore intended that such changes and modifications be covered by the appended claims.

What is claimed is:

1. A material placer comprising:
a material hopper;
a primary conveyor, the primary conveyor configured to cooperate with the material hopper;
a secondary conveyor having an in-feed end and a discharge end, the in-feed end alignable with the primary conveyor, wherein the secondary conveyor is a high-speed conveyor; and
a body coupled to an off-road frame, the body configured to support the primary and secondary conveyors, and wherein the off-road frame is configured to traverse rough terrain.

2. The material placer of claim 1, further comprising a leveling cylinder coupled to the body and the off-road frame.

3. The material placer of claim 1, wherein the off-road frame includes at least one crab axle.

4. The material placer of claim 1, wherein the off-road frame cooperates with tires selected from the group consisting of off-road tires and flotation tires.

5. The material placer of claim 1, further comprising a remote control system configured to control the operation of the primary and secondary conveyors, and the body.

6. The material placer of claim 1, wherein the high-speed conveyor is a placer conveyor configured with a high-speed motor to rapidly throw material across a construction site.

7. The material placer of claim 1, further comprising a tertiary conveyor configured to cooperate with the primary conveyor and the material hopper.

8. The material placer of claim 7, wherein the tertiary conveyor is a feeder conveyor that supports a feeder hopper, the feeder hopper configured to cooperate with the material hopper.

9. The material placer of claim 7, wherein the tertiary conveyor is adjustable between an inclined loading position and a substantially horizontal feed position.

10. The material placer of claim 1, wherein the off-road frame is a truck chassis.

11. The material placer of claim 1, wherein the primary conveyor is a removable cartridge conveyor.

12. A material placer comprising:
an all-terrain frame having:
a first steering axle; and
a second steering axle, wherein the second steering axle is independently steerable relative to the first steering axle;
a body pivotally coupled to the all-terrain frame;
a material hopper coupled to the body, the material hopper configured to receive and store material;
a primary conveyor coupled to the body, the primary conveyor is configured to receive material stored by the material hopper; and
a secondary conveyer coupled to the body, the secondary conveyor configured to receive material from the primary conveyor and discharge the material at a discharge end.

13. The material placer of claim 12, further comprising a deflector mounted adjacent to the discharge end.

14. The material placer of claim 12, further comprising at least one leveling cylinder pivotally coupled to the body and the all-terrain frame, wherein the at least one leveling cylinder is extendable between a first extended portion and a second retracted position.

15. The material placer of claim 12, wherein at least one of the first and second steering axles is a crab axle.

16. The material placer of claim 12, wherein at least one of the first and second steering axles cooperates with tires selected from the group consisting of off-road tires and flotation tires.

17. The material placer of claim 12, further comprising a remote control system configured to control at least the operation of the primary and secondary conveyors, and the body.

18. The material placer of claim 12, wherein the secondary conveyor is a placer conveyor configured with a high-speed motor to rapidly throw material.

19. The material placer of claim 12 further comprising a tertiary conveyor configured to continuously cooperate with the primary conveyor and the material hopper.

20. The material placer of claim 19, wherein the tertiary conveyor is a feeder conveyor that supports a feeder hopper, the feeder hopper configured to cooperate with the material hopper.

21. A material placer comprising:
a frame;
a body coupled to the frame;
a primary conveyor coupled to the body;
a secondary conveyer coupled to the body, the secondary conveyor configured as a high-speed conveyor to receive material from the primary conveyor and throw the material at a discharge end; and
a tertiary conveyor configured to continuously cooperate with the primary conveyor.

22. The mobile placer of claim 21, wherein the frame is an all-terrain frame.

23. The mobile placer of claim 21, wherein the primary conveyor is a cartridge conveyor.
